(19) United States
(12) Patent Application Publication
(10) Pub. No.: US 2021/0081363 A1
(43) Pub. Date: Mar. 18, 2021

(54) METHODS AND SYSTEMS OF ENABLING DOCUMENT SHARING IN CO-BROWSING SESSIONS

(71) Applicant: Avaya Inc., Santa Clara, CA (US)

(72) Inventors: Avinash Anand, Maharashtra (IN); Neha Kumari, Jharkhand (IN)

(21) Appl. No.: 16/570,221

(22) Filed: Sep. 13, 2019

(51) Int. Cl. G06F 16/176; G06F 16/957; G06F 16/958; G06F 16/955

(52) U.S. Cl. CPC G06F 16/176; G06F 16/9558; G06F 16/986; G06F 16/957

(57) ABSTRACT

Embodiments described herein provide systems and methods for enabling document sharing in a co-browsing session. In a particular embodiment, a method provides performing operations as follows on a processor of a computer system: initiating the co-browsing session; generating a graphical user interface (GUI) of the co-browsing session configured to display on a user device; receiving a document to be shared in the co-browsing session from the user device via a network location; in response to receiving the document, converting the document to an HTML format version of the document; and appending the HTML format version of the document to the GUI, wherein the GUI is configured to dynamically display the HTML format version of the document on the user device.

### FIELD

The present disclosure is generally directed to collaboration software systems and, in particular, toward methods of sharing documents in co-browsing sessions.

### BACKGROUND

Cobrowsing applications are increasingly becoming more important tools within collaborative environments. Cobrowsing applications enable multiple users view and/or navigate Internet webpages or other Internet resources. Using cobrowsing applications, several users can view a webpage simultaneously while participating in a collaboration session. For example, users participating in a conference call may find a need to view a webpage together. A first user on the conference call can open a webpage in a cobrowsing application. Other users on the conference call can join the cobrowsing application and view the webpage with the first user.

Cobrowsing applications can take the form of a web application which executes inside an Internet browser. These cobrowsing applications are typically initiated from a special Uniform Resource Locator (URL) associated with the cobrowsing application. The URL can initialize the cobrowsing application and enable synchronized navigation within the cobrowsing application to occur.

A benefit of cobrowsing applications as opposed to simple screensharing applications is increased privacy. Users do not need to worry about other applications running on their computers before beginning a cobrowsing application. For example, a user with an Excel file containing sensitive information can keep the Excel file open during the cobrowsing application without the risk of the content of the Excel file being disclosed during the collaborative session.

Web cobrowsing applications do not have ability to collaborate anything outside of the context of browser window. In reality a user in a cobrowsing session may need seek help regarding a document stored in his local computer.

### BRIEF DESCRIPTION OF THE DRAWINGS

FIG. 1 shows a computer network environment in accordance with one or more of the embodiments described herein;

FIG. 2 shows a computer system in accordance with one or more of the embodiments described herein;

FIGS. 3A-3C are diagrams of embodiments of graphical user interfaces (GUIs) in accordance with one or more of the embodiments described herein;

FIG. 4 is a diagraph of an embodiment of a GUI in accordance with one or more of the embodiments described herein;

FIG. 5 is a flow chart of a method in accordance with one or more of the embodiments described herein;

FIG. 6 is a flow chart of a method in accordance with one or more of the embodiments described herein; and

FIG. 7 is a flow chart of a method in accordance with one or more of the embodiments described herein.

### DETAILED DESCRIPTION

While cobrowsing is a beneficial application, cobrowsing is limited in its ability for users to share documents. In conventional cobrowsing applications, users cannot adequately collaborate on non-HTML documents such as Word and Excel documents. Embodiments of the present disclosure describe how formatted documents available in a file system of a user device can be used to share during an active web collaboration. The entities involved in a web collaboration known as cobrowsing use a web page to share information to all the participants joined in the session.

In certain embodiments of the disclosure, a transformer available in web application can dynamically convert a formatted document into a HTML format to be attached in an iFrame or Canvas element of a web page in a cobrowsing application.

Further, with the virture of a cobrowsing application to support an iFrame or Canvas for cobrowse, the document can be made available for cobrowsing and tools like marking and annotation can be used to highlight certain sections of the page.

Due to this limitation, cobrowsing is not as useful a tool as required by contemporary computer users. What is needed is a way for users to be capable of sharing documents in a cobrowsing application without requiring additional software applications.

Embodiments of the present disclosure will be described in connection with a computer-implemented method for enabling document sharing in a co-browsing session. In some embodiments, the method may comprise performing operations as follows on a processor of a computer system: initiating the co-browsing session; generating a graphical user interface (GUI) of the co-browsing session configured to display on a user device; receiving a document to be shared in the co-browsing session from the user device via a network location; in response to receiving the document, converting the document to an HTML format version of the document; and appending the HTML format version of the document to the GUI, wherein the GUI is configured to dynamically display the HTML format version of the document on the user device. Such operations may be as described in greater detail below.

In some embodiments, converting the document to the HTML format version of the document may comprise extracting textual data from the document. For example, a word document with background images, colorful text, etc. may be reduced to a plain text file. Similarly, a PDF image file may be reduced to text using OCR or other text detection systems. Reducing a document in such a way may be beneficial by reducing required bandwidth to share the document. In some embodiments, the GUI may be configured to dynamically display the HTML format version of the document on the user device in plain text and without styling elements. Again, by avoiding the sharing of styling elements, bandwidth requirements may be reduced. In some embodiments, such a feature may be an option capable of being selected by users. A transformer system may convert a document to be shared into a formatted HTML retaining all the nuances of the original document like Paragraph, Bold, Underline, Sequencing, Pictures etc.

In some embodiments, the GUI is configured to dynamically display the HTML format version of the document in a modal window on the user device. For example, a popup, or modal, window may be presented on each user's display over or alongside the GUI containing the cobrowsing session. In other embodiments, the HTML format version of the document may be presented within the same window as the cobrowsing session. By providing the HTML format version of the document in a modal window, users may be better enabled to view multiple shared documents. For example, users may share a plurality of documents and each document may be displayed in a separate modal window.

The HTML format document may be made available in the currently browsed webpage. For example, if a user visits a webpage during a cobrowsing session and uploads a document, the document is transmitted to the server hosting the cobrowsing session, and the server transforms it into an equivalent HTML complement, and that HTML complement is dynamically inserted in the webpage in a format such that it is available and viewable to the customer. In some embodiments, the document may be presented in a modal dialogue, a pop-up window, or a placeholder inside the webpage, which would be occupied by the HTML format document or which would be hosting the transformed document's HTML equivalent.

In some embodiments, the method may comprise receiving authorization from the user device to enable a second user device to edit the HTML format version of the document. Upon uploading a document, a user may be capable of setting authorizations for the document. Authorizations may be set automatically or may be set manually or may be customizable. For example, a user may click an upload document button, the user may be presented with a file navigation window to locate the document, the document may be uploaded, and an HTML version of the document may be presented to all users of the cobrowsing session. Depending on user settings, the document may either be editable by all or some users. In some cases, the document may be at first editable by only the first user. The GUI may present additional settings for the first user to allow permission to other users. For example, the first user may select one or more of the other users to allow read/write permission for the document.

In some embodiments, the method may comprise converting the HTML format version of the document to a different file type and transmitting the converted HTML format version of the document to the second user device. For example, the GUI may provide users options to save an offline version of the HTML format version of the document. Upon selecting a save offline version button, the document may be converted back to the same format it was as uploaded. In some embodiments, converting the HTML format version of the document to a different file type may comprise restoring styling elements to the HTML format version of the document.

By enabling users to share documents in a cobrowsing application, the collaborative environment of a cobrowsing application may be more useful and effective. Users may not be required to install additional applications or to browse to other webpages to access documents to collaborate.

Documents shared in cobrowsing applications may be used by the participants of a cobrowsing session to communicate. For example, a simple text file shared between the participants in the session that is editable by one or more participants may be used to type messages to each other. Such a feature is an improvement over conventional cobrowsing applications.

Embodiments of the present disclosure will be described in connection with a computer-implemented method for enabling document sharing in a co-browsing session. The computer-implemented method may be executed on one or more servers such as a webserver or may be executed on one or more personal computer devices. In some embodiments, the method may comprise initiating the co-browsing session. For example, as discussed herein, initiating the cobrowsing session may involve users sharing a URL to a webpage in which a cobrowsing application may be initiated. In some embodiments, a cobrowsing session may involve using an application executing on a personal computer system. One or more participants to the cobrowsing session may log into such an application and join the session.

In some embodiments, the method may comprise generating a GUI of the co-browsing session configured to display on a user device. For example, a GUI may be presented within a web-based application executing in a browser or may be presented within a window of a cobrowsing application executing on a user device. The GUI may present options for participants of the cobrowsing session, such as options to add participants, upload documents, edit permissions for shared documents, and other settings.

In some embodiments, the method may comprise receiving a document to be shared in a cobrowsing session from the user device via a network location. For example, the method may be executing on a webserver. A participant of the cobrowsing session may select an upload document GUI button, select a document from his or her computer, and begin the upload process. The document may be transmitted to the webserver or other entity executing the method. In some embodiments, the document may first be compressed before being transmitted.

In some embodiments, the method may be executing via an application on the user's computer. In such a scenario, receiving the document to be shared may comprise the document being identified and located by the application.

The method may comprise, in response to receiving the document, converting the document to an HTML format version of the document. The server(s) or computer system(s) executing the method may execute a process of analyzing elements of the document to find text, images, and other translatable elements. Such elements may be extracted and compiled into an HTML document, creating an HTML format version of the document.

In some embodiments, the method may comprise appending the HTML format version of the document to the GUI, wherein the GUI is configured to dynamically display the HTML format version of the document on the user device. For example, after the HTML format version of the document is created by the server(s) or computer system(s) executing the method, the cobrowsing session may render and display the HTML format version of the document in a window for users of the cobrowsing session to view and/or edit. This formatted HTML is rendered inside a pre-existing HTML element in the page like iFrame or canvas.

By virtue of the support available for iFrame and Canvas element in the webpage, the uploaded document from local PC of the user may be available for collaboration and run time Edit by users by passing control during session to other users.

When the collaboration completes, the user who was sharing his view of web page can download the modified (after collaboration) copy of document from the webpage and save it in his local computer in the original MIME Type. Using this transformer, we will change this document's MIME type into an equivalent HTML type.

For example, if a user has a Microsoft Word document available on his or her computer, an HTML equivalent of that document may be generated and be present on the server hosting the cobrowsing session.

Such a method may enable participants of a cobrowsing session to share documents and to collaborate on such documents during the session and avoid the necessity to use other software applications in addition to cobrowsing. These and other operations may be as described in greater detail below.

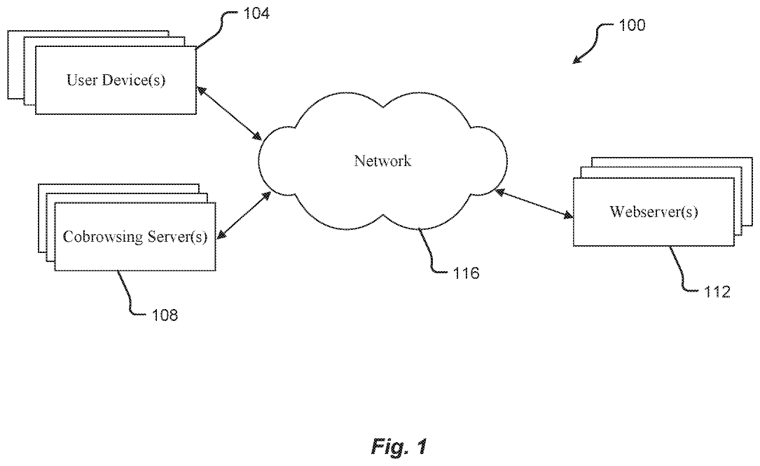

In some embodiments, a computer-implemented method for sharing documents in a cobrowsing session may execute in an environment 100 including one or more user device(s) 104, one or more cobrowsing server(s) 108, and/or one or more webserver(s) 112 connected via a network 116 as illustrated in FIG. 1. By interconnecting one or more user device(s) 104, one or more cobrowsing server(s) 108, and/or one or more webserver(s) 112 via a network 116, a cobrowsing session may be implemented allowing users of the user device(s) 104 to via a cobrowsing GUI.

User device(s) 104 may in some embodiments comprise personal computers, laptops, tablet devices, smartphones, or any other type of device capable of executing a cobrowsing application or Internet browser. In some embodiments, a cobrowsing session may be executed within a browser window such as Internet Explorer™, Google™ Chrome™, Firefox™, etc. and may be implemented using a Javascript™ application.

The environment 100 may comprise one or more cobrowsing server(s) 108. Cobrowsing servers 108 may be dedicated servers configured to host one or more cobrowsing sessions for a multitude of users. In some embodiments, one or more cobrowsing servers 108 may be required in environment 100 as webservers 112 may be capable of hosting only static web content. The logic for hosting a multitude of cobrowsing sessions is available through cobrowsing servers only.

Also specialized logic for masking certain portions of the document being shared would again be available through cobrowse server.

Webserver(s) 112 may comprise network connected computer systems hosting one or more webpages. Information hosted on webservers 112 may be accessed during cobrowsing sessions and may be displayed in GUI elements on one or more user devices via browser windows.

A cobrowsing server 108 and/or webserver 112 can be or may include any server that is capable of executing a cobrowsing session between two or more user devices 104 to view web pages provided by a web server 112.

The webserver 112 can be or may include any software/hardware that can work with a browser to provide one or more web pages, such as Apache®, Nginx®, Microsoft-ITS®, Tomcat®, and/or the like. The web servers 112 may comprise a plurality of different web servers 112 from different companies, enterprises, groups, and/or the like. The web server 112 provides web page(s) that can be viewed by a user running a browser on a communication endpoint.

A network 116 may be a private network, a local-area network, or a wide-area network such as the Internet. For example, a private network accessible within a corporation may host a cobrowsing system, while in some embodiments cobrowsing may take place across the Internet.

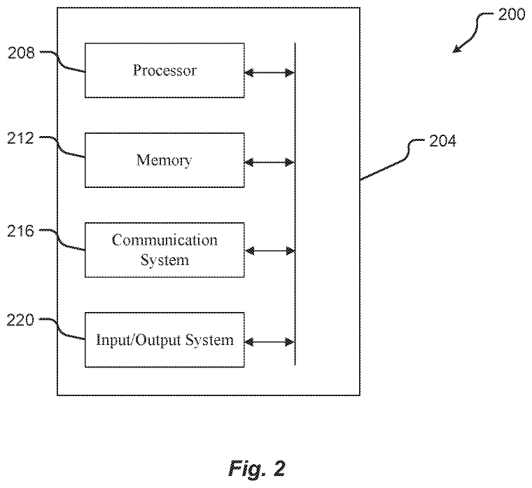

Any of the user devices 104, servers 108, 112, and/or other computer systems as described herein may be as illustrated in FIG. 2. A computer system 204 may comprise a processor 208, a memory element 212, a communication system 216, and an input/output system 220.

A processor 208 can be or may include any hardware processor, such as a Digital Signaling Processor (DSP), an application specific processor, a microcontroller, a multi-core processor, and/or the like. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM1926EJ-S™ processors, other industry-equivalent processors, and may perform computational functions using any known or future-developed standard, instruction set, libraries, and/or architecture.

A memory element 212 may be any computer readable storage medium, such as a memory (i.e., a computer memory, a hard disk, and/or the like). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A communication system 216 can be or may include any hardware interface coupled with software that can communicate with the network 116. For example, the communication system 216 can be a wireless interface, a wired interface, a fiber optic interface, an Ethernet interface, a cellular interface, a WiFi interface, and/or the like.

An input/output system 220 can be or may include any type of hardware interface coupled with software that can communicate with a user of the computer system 200. For example, keyboard, mouse, display screen, microphone, speaker, etc.

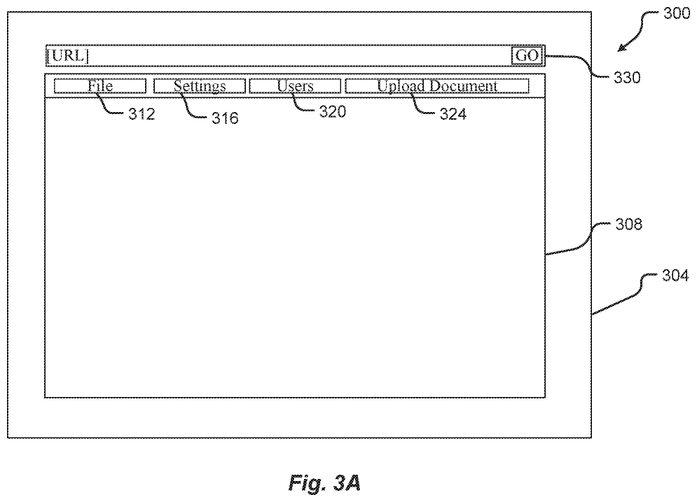

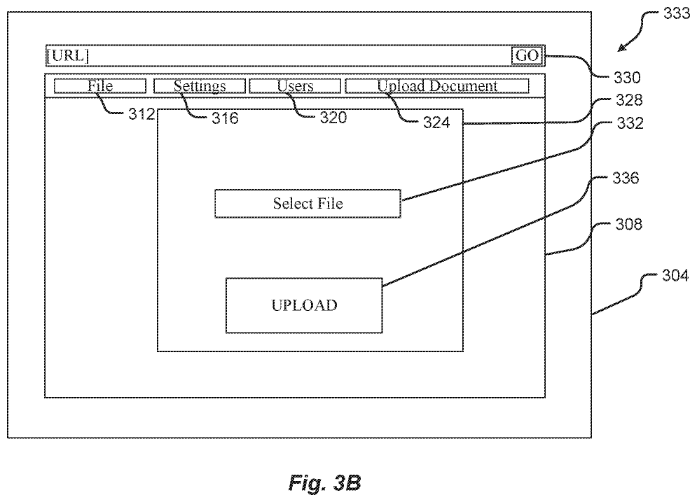

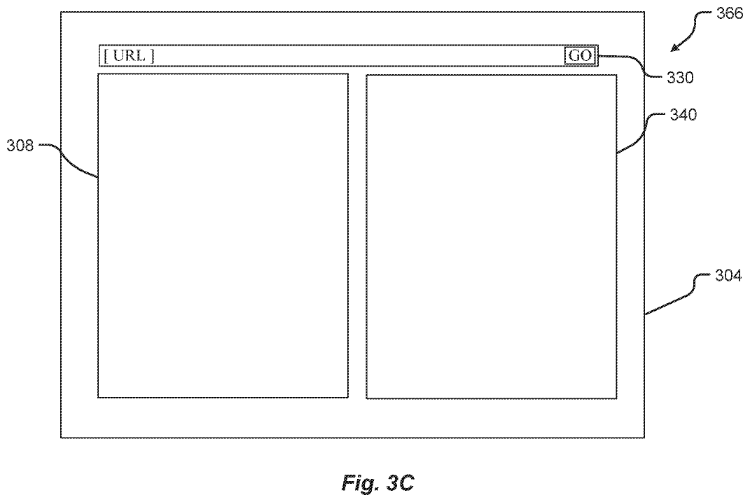

FIGS. 3A-3C are illustrations of a browser executing a cobrowsing session on a user device. The browser displays a web page available on the web server. A cobrowsing session may include a java script run-time engine to interpret java script and/or HTML of a web page for view by a user in the browser.

User interface elements described herein can be or may include any type of user interface element that can be displayed/sounded by a browser such as a button, a window, a pane, panel, a menu, a menu item, an icon, a tab, a text object, a text entry object, a scroll bar, a slider, a cursor, a picture, a video, a sound object, a vibration object, and/or the like.

When a user accesses a web page using the browser, web page code may be loaded from a webserver or other network location. For example, when the user enters a Uniform Resource Locator (URL) in the browser, code from the web page associated with the URL may be loaded in the browser.

As illustrated in FIG. 3A, a cobrowsing session may comprise a user interface 300 displayed on one or more user devices. The user interface may include an outer window 304 containing a number of GUI elements. The outer window 304 may include a browser window 308 displaying cobrowsing material. The user interface 300 may comprise a series of GUI buttons such as a file button 312, a settings button 316, a users button 320, and/or an upload document button 324. The GUI buttons 312, 316, 320, 324 may be loaded in the browser window 308 after a user navigates to a cobrowsing session and the browser loads the cobrowsing application. The user interface 300 may also include a navigation bar 330 enabling users to select a URL to visit in the browser window 308.

A browser window 308 may be configured to display the contents of a webpage accessed from a network location. During a cobrowsing session, multiple users at multiple user devices 104 may share a view of the browser window 308.

A navigation bar 330 may be used to enable users to select a URL to visit in the browser window 308. Entering a URL and submitting or clicking an enter or go button may begin a downloading of contents from the URL into the browser window 308.

Once a cobrowsing page is loaded inside the browser window 308, a series of graphical user interface buttons 312, 316, 320, 324 enabling users to interact with the cobrowsing session may be presented to the user. Such buttons 312, 316, 320, 324 may enable users to interact with the cobrowsing session and to share documents in the cobrowsing session. For example, a file button 312 may present a dropdown menu providing a number of options such as exit, new window, etc. A settings button 316 may present a pop-up or modal window listing a series of options for user-customizable settings. A users button 320 may present a list of users participating in the cobrowsing session and may provide options such as adding or dropping participants, muting participants, setting permission levels for participants, etc. An upload document button 324 may begin a process of uploading a document from the user device to share in the cobrowsing session in a converted format as described herein.

As illustrated in FIG. 3B, a user interface 333 may display a document upload GUI element 328 including a select file button 332 and an upload button 336. A document upload GUI element 328 may be presented following a user selecting an upload document button 324. In some embodiments, while the browser window 308 may be presented on all participant's display devices, the document upload GUI element 328 may display only on the display of the user that selected the upload document button 324. By selecting the select file button 332, the user may be presented with a file navigation window enabling the user to select a file to upload and share in the cobrowsing session.

As illustrated in FIG. 3C, a user interface 366 may display a rendered HTML format version of an uploaded document in a modal window 340. The rendered HTML format version of the uploaded document may be displayed in the modal window 340 after a process of uploading a document from the user device to share in the cobrowsing session in a converted format as described herein. In some embodiments, the rendered HTML format version may appear in the browser window 308 as opposed to the modal window 340. In some embodiments, the modal window 340 may totally or partially obscure a view of the browser window 308. The modal window 340 may be moveable by one or more participants of the cobrowsing session.

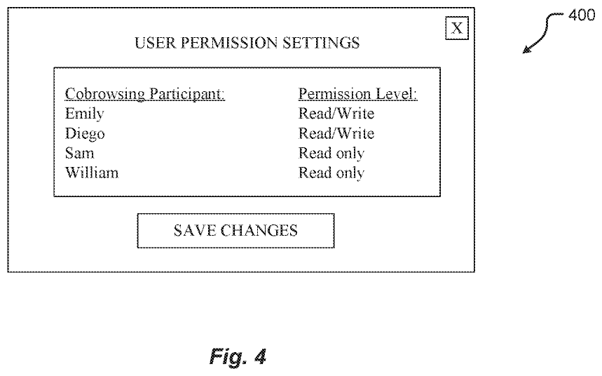

As illustrated in FIG. 4, a user permission settings GUI element 400 may be used to set permissions for participants of the cobrowsing session. For each document shared in a cobrowsing session, each participant may have a permission level associated with the document. For example, a participant may have read only or read/write permission for a given document. If the participant has read only permissions for a document, the participant may be enabled to view the document in the cobrowsing session while a participant with read/write permissions may be capable of viewing and editing the document. Using a user permission settings GUI element 400, a user may be capable of adjusting permissions for other users. In some embodiments, only the user who has uploaded the document may adjust the permissions. In other embodiments, any user with read/write permission may adjust the permissions. It should be appreciated that other configurations may be implemented.

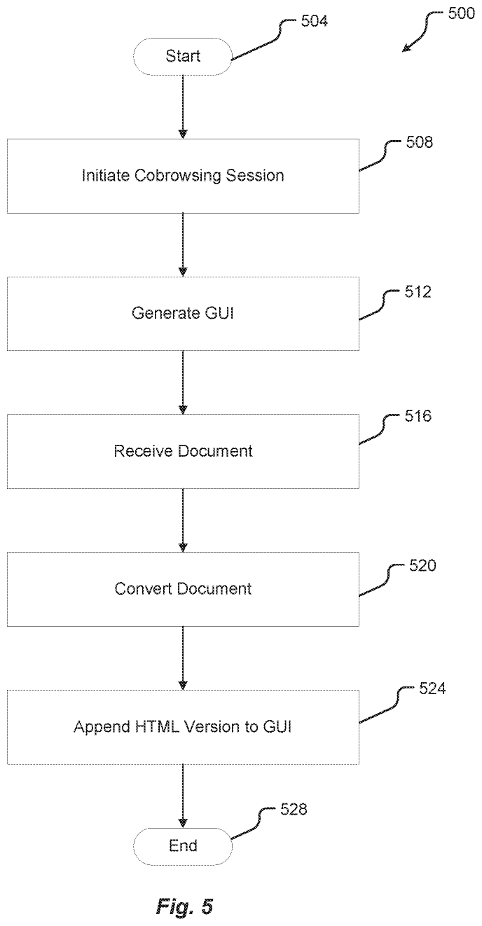

In some embodiments, the systems and methods described herein may be executed on one or a combination of a cobrowsing server, a webserver, or a user device. FIGS. 5-7 are flow diagrams of processes of browsers executing cobrowsing sessions. Browsers executing on user devices may display GUI elements and may be in communication with one or more other user devices, one or more cobrowsing servers, and/or one or more webservers via a network location. The methods described herein and illustrated by the flow diagrams of FIGS. 5-7 may be executed by processors or microprocessors of computer devices which may perform the methods. The processes described herein may be performed by executing program instructions stored in a computer readable storage medium such as a memory device. Although the methods described in relation with FIGS. 5-7 are shown in a specific order, one of skill in the art would recognize that the steps in FIGS. 5-7 may be implemented in different orders and/or be implemented in a multi-threaded environment. Moreover, various steps may be omitted, added, or repeated based on implementation.

The process 500 of FIG. 5 is from a perspective of a computer application executing a cobrowsing session. The process 500 starts in step 504 in which a user device capable of executing a browser application is used by a user to join a cobrowsing session. In some embodiments, such a cobrowsing session may be hosted by a user device or in some embodiments a cobrowsing server or webserver. The cobrowsing session may be accessed by a plurality of cobrowsing participants. Each participant may view the same or a similar view in a GUI displayed on his or her user device.

In step 508, the cobrowsing session may be initiated. Initiating the cobrowsing session may comprise the user creating a new cobrowsing session or joining an existing cobrowsing session. Step 508 may be triggered by a request from the user of the user device. For example, the user may click a hyperlink which may activate a JavaScript application executing in his or her browser to one of join an existing cobrowsing session or create a new cobrowsing session.

In step 512, a GUI may be generated on a display screen of the user's user device. The GUI may be as or similar to the GUI illustrated in FIG. 3A. The GUI may display a blank screen with a browser toolbar enabling the user to access a URL. The GUI may display a webpage accessed via the cobrowsing session by one or more of the participants.

In step 516, a document may be received by the cobrowsing application. This step may be implemented by the user device or by a server or other computing device hosting the cobrowsing session. For example, a user participant of the cobrowsing session may click a GUI element requesting to share a document in the cobrowsing session. The user may be presented with a navigation window enabling the user to locate and select a document on the user's user device. Once the user has selected the document to be shared, the document may be transmitted to the computer system hosting the cobrowsing session or conversion and/or translation process described herein may be performed by the user's user device.

In step 520, the document may be converted to an HTML file or other filetype capable of being displayed by the cobrowsing application. The conversion and/or translation process may be performed by the user device of the user seeking to upload the document or by the computer system or server hosting the cobrowsing session.

Converting a document to HTML may consist of taking text elements from the document to be shared and inserting into an HTML file. HTML markup consists of several key components, including tags and their attributes, character-based data types, character references and entity references. HTML tags may come in pairs like <h1> and </h1>, although some represent empty elements and so are unpaired, for example <img>. The first tag in such a pair is the start tag, and the second is the end tag (they are also called opening tags and closing tags). Another important component is the HTML document type declaration, which triggers standards mode rendering. The following is an example of contents of an HTML file:

<!DOCTYPE html>

<html>

<head>

<title>Document Title</title>

</head>
<body>

<p>Hello world!</p>

</body>

</html>

The text between <html> and </html> describes the web page, and the text between <body> and </body> is the visible page content. The markup text <title>This is a title</title> defines the browser page title. The Document Type Declaration <!DOCTYPE html> is for HTML5. As a very general example, if a Word document to be shared simply contains the words “Hello world!” the above example HTML file could be used as the converted document to be shared. As should be appreciated, more complex documents can be shared in similar ways.

In step 524, the HTML version of the document may be appended to the GUI. For example, the HTML version of the document may be displayed within the main screen of the cobrowsing application or within a modal window displayed on the screen of the cobrowsing application.

The process 500 ends at step 528. At the end of the process 500, the cobrowsing session may continue with each participant being enabled to view the shared HTML version of the document on his or her user device. For example, the shared document may be displayed in a modal window within the cobrowsing application executing within a browser on the user device. Each user may be capable of editing the document within the cobrowsing session based on his or her permission levels set within the cobrowsing application for the session.

When a user desires to share a document in a cobrowsing session the user may browse his/her user device to select a document from a location on a drive on the user device. The location of the document may be transmitted to the cobrowsing application executing on the user device. The cobrowsing application may then begin a process of uploading the document to be shared.

In many cases, the document to be shared will be of a format other than HTML. In such cases, the document must be converted or translated to an HTML version before being shared in the cobrowsing session.

Documents to be shared may, for example, be PDFs, Word documents, Excel files, text files, etc. Each document type may be associated with a different type of conversion process. Many such conversion processes should be known by persons of skill in the art. For example, Microsoft™ Word™ includes a built-in save-as-HTML function. Standalone applications also exist for converting PDF, Word, Excel, and other document types to HTML format documents. It should be appreciated that while the present disclosure describes documents being shared in an HTML format, other file types capable of being presented in a cobrowsing session may also be used. The present disclosure provides an ability to take back locally stored files in a specific MIME format to be available inside the webpage. In order to solve this problem, the present disclosure allows for a simple GUI element inside the document webpage, using which the customer could upload a document to the co-browsing server.

Hypertext Markup Language (HTML) is a markup language for documents designed to be displayed in a web browser. HTML can be assisted by technologies such as Cascading Style Sheets (CSS) and scripting languages such as JavaScript.

Web browsers receive HTML documents from a web server or from local storage and render the documents into multimedia web pages. HTML describes the structure of a web page semantically and originally included cues for the appearance of the document.

HTML elements are the building blocks of HTML pages. With HTML constructs, images and other objects such as interactive forms may be embedded into the rendered page. HTML provides a means to create structured documents by denoting structural semantics for text such as headings, paragraphs, lists, links, quotes and other items. HTML elements are delineated by tags, written using angle brackets. Tags such as <img/> and <input/> directly introduce content into the page. Other tags such as <p> surround and provide information about document text and may include other tags as sub-elements. Browsers do not display the HTML tags, but use them to interpret the content of the page.

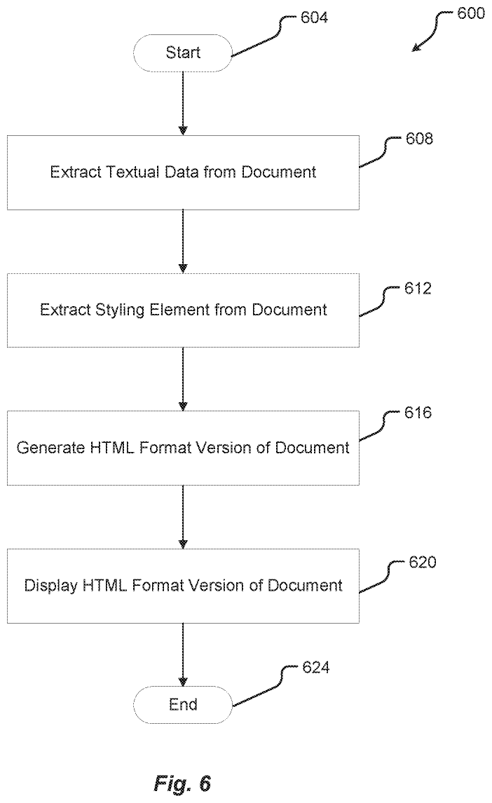

The process 600 of FIG. 6 is from a perspective of a computer application executing a cobrowsing session. The process 600 may take place during a cobrowsing session in which one or more users of user devices are participating. The process 600 starts in step 604 in which a computer system hosting a cobrowsing session receives a document to be shared in the cobrowsing session. For example, and as discussed herein, the computer system hosting the cobrowsing session may receive such a document as a result of a user requesting to share the document, locating the document on the user's user device, and uploading the document into the cobrowsing application executing in a browser.

In step 608, textual data may be extracted from the document to be shared as part of the upload and HTML conversion process. To reduce the amount of bandwidth required to upload and present the document contents, user settings may exist enabling uploading users to limit the contents of the document being shared.

Typically, a document to be shared may contain text. Often a document to be shared may contain a combination of text and styling elements. For example, a Word document may contain paragraphs of text. The text may be formatted in bold, italics, underlined, superscript, subscript, left aligned, right aligned, centered, justified, etc. Styling elements may include such formatting information and/or may include images, background images, header information, footer information, hyperlink information, etc.

Converting a document to be shared may comprise extracting text from the document and creating a text only version of the document. A text only version may be simple, plain text, or may include formatted text.

In some embodiments, a user seeking to share a document may be presented with a menu option to reduce the file size of the document to be shared. For example, a slider may be presented offering a range of plain text, to formatted text, to full text with full style details, and other levels of text in between.

Sharing a text-only version, or otherwise limited version, of the document may be beneficial to reduce bandwidth requirements which may improve the overall cobrowsing experience for the users participating.

In some embodiments, the styling information may be extracted and saved in a separate file. For example, if all images are to be removed from the document to be shared, the images may be saved in a second file along with information such as image location data such that the styling information file may be used to restore the HTML version of the document to be shared to the original filetype with the styling elements re-inserted. In step 612, styling elements may be extracted from the document to be shared and may be saved in a separate file. Note that in some embodiments such a step may be omitted from the process 600.

In step 616 an HTML format version of the document to be shared may be generated. In some embodiments, an off-the-shelf HTML conversion process may be used. In some embodiments, the HTML conversion process may be a simple copying of the contents of the document into a shell of an editable HTML document. In some embodiments the HTML format version of the document to be shared may be generated by the uploading user device while in other embodiments the document may first be sent to a server or other computer system hosting the cobrowsing session.

In step 620 the HTML format version of the document to be shared may be displayed on user devices participating in the cobrowsing session as part of the cobrowsing session via the cobrowsing applications executing within browsers on the user devices. The HTML format version of the document to be shared may be displayed in an editable format such that user's with editing permissions may be permitted to markup the documents, insert, edit and/or remove text and remove images, add comments, etc.

The process 600 ends at step 624 at which point the users participating in the session may view and/or edit the document while continuing the cobrowsing session.

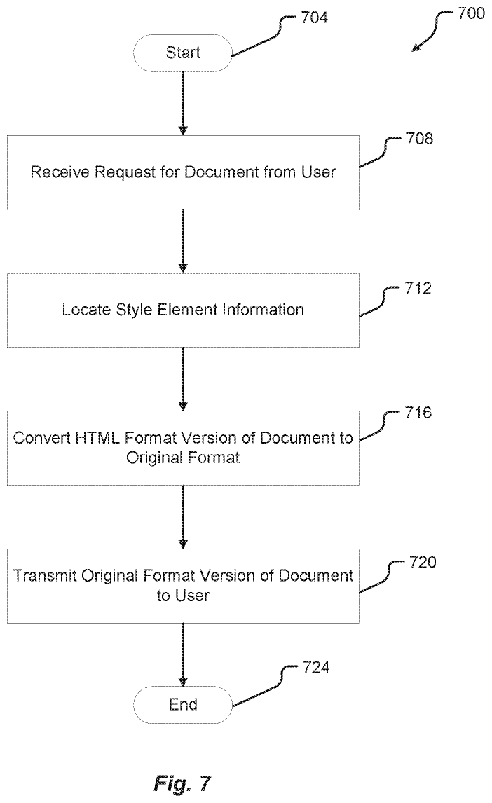

The process 700 of FIG. 7 is from a perspective of a computer application executing in association with a cobrowsing session. The process 700 starts in step 704 in which a computer system is hosting a cobrowsing session in which a document converted to HTML format is being shared. During the cobrowsing session, the document may have been edited by one or more users and may exist in a state quite unlike that which was originally selected to be shared and uploaded.

In step 708, a request for the document may be received from a user participating in the cobrowsing session. During a cobrowsing session a user viewing a shared document may desire to save an offline version of the shared document. The user may select a download shared file link or other type of GUI element indicating an offline version of the document being shared is requested. In some embodiments, the user may first be presented with an option to download either the original, unedited document or the document as edited during the cobrowsing session. If the user selects to download the original, unedited document, the user may be sent the original file as uploaded. If the user requests the document as edited, the shared document may be re-converted back to its original file type. Converting the shared document back to its original format may comprise converting the shared document and reinserting any and all styling elements back into the document.

In some embodiments, re-converting the document may comprise modifying the original file to include any changes made during the cobrowsing session. For example, as a document being shared in a cobrowsing session is edited, any changes made may be logged. Such changes may be made to the original file either in real-time, when a user requests an offline version, or at the end of the cobrowsing session.

In some embodiments, re-converting the document may comprise combining the text document as modified during the cobrowsing session with a style file containing style information generated during the upload and conversion process for the document at the time the document was uploaded into the cobrowsing session.

In step 712, style elements for the document may be located. As discussed herein, style elements contained in the original document to be shared may be extracted and saved in a separate file. In such a scenario the style file may be located for the re-conversion process.

In step 716, the HTML format version of the document being shared may be converted to its original format. In some embodiments, re-converting the document may comprise first determining that changes have been made before going through the process of converting the file back to its original format. For example, during a cobrowsing session during which a document is being shared, any edits made to the document may be tracked by one or more of a computer system or server hosting the cobrowsing session or a computer device of one or more users participating in the cobrowsing session. Any changes made to the document may be tracked. Information relating to such changes may be used in the re-conversion process.

In some embodiments, re-converting the document may comprise determining that no changes have been made and simply transmitting the original file, pre-conversion. For example, if no changes or edits to the shared document are recorded, the re-conversion process may be made more efficient by not converting the HTML file back to the original filetype but by simply allowing users requesting an offline version of the document to save the original file.

The re-conversion process may be implemented by the user device of the request user or by a server or other computer system hosting the cobrowsing session. In some embodiments, the user device which uploaded the shared document may be used to restore the converted document to the original filetype and then transmit the re-converted document to the requesting user device in its original filetype.

In step 720 the converted document may be transmitted in its original format to the requesting user. In some embodiments, such a step may comprise presenting the requesting user a GUI element with a document download link or may comprise beginning the download of the document to the requesting user's user device via the cobrowsing application browser window.

The process 700 ends at step 724 at which point the cobrowsing session may continue. Other participants may request the document being shared and the document being shared may continue to be edited. The process 700 may also take place at the end of cobrowsing sessions. For example, upon ending a cobrowsing session, one or more of the users participating may be presented with a notification and a query enabling the users to download one or more documents which were shared in the cobrowsing session. The users may use such a notification to request copies of the documents either as edited or as originally selected to be uploaded and shared. Following the process 700, the cobrowsing session may continue or may end.

Any of the steps, functions, and operations discussed herein can be performed continuously and automatically.

The exemplary systems and methods of this disclosure have been described in relation to cobrowsing software applications. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a computer-implemented method for enabling document sharing in a co-browsing session, the method comprising performing operations as follows on a processor of a computer system: initiating the co-browsing session; generating a graphical user interface (GUI) of the co-browsing session configured to display on a user device; receiving a document to be shared in the co-browsing session from the user device via a network location; in response to receiving the document, converting the document to an HTML format version of the document; and appending the HTML format version of the document to the GUI, wherein the GUI is configured to dynamically display the HTML format version of the document on the user device.

Aspects of the above method may further comprise wherein converting the document to the HTML format version of the document comprises extracting textual data from the document.

Aspects of the above method may further comprise wherein the GUI is configured to dynamically display the HTML format version of the document on the user device in plain text and without styling elements.

Aspects of the above method may further comprise wherein the GUI is configured to dynamically display the HTML format version of the document in a modal window on the user device.

Aspects of the above method may further comprise receiving authorization from the user device to enable a second user device to edit the HTML format version of the document.

Aspects of the above method may further comprise converting the HTML format version of the document to a different file type and transmitting the converted HTML format version of the document to the second user device.

Aspects of the above method may further comprise wherein converting the HTML format version of the document to a different file type comprises restoring styling elements to the HTML format version of the document.

Embodiments include a system for enabling document sharing in a co-browsing session, the system comprising: a processor; and a computer-readable storage medium storing computer-readable instructions which, when executed by the processor, cause the processor to perform steps comprising: initiating the co-browsing session; generating a graphical user interface (GUI) of the co-browsing session configured to display on a user device; receiving a document to be shared in the co-browsing session from the user device via a network location; in response to receiving the document, converting the document to an HTML format version of the document; and appending the HTML format version of the document to the GUI, wherein the GUI is configured to dynamically display the HTML format version of the document on the user device.

Aspects of the above system may further comprise wherein converting the document to the HTML format version of the document comprises extracting textual data from the document.

Aspects of the above system may further comprise wherein the GUI is configured to dynamically display the HTML format version of the document on the user device in plain text and without styling elements.

Aspects of the above system may further comprise wherein the GUI is configured to dynamically display the HTML format version of the document in a modal window on the user device.

Aspects of the above system may further comprise receiving authorization from the user device to enable a second user device to edit the HTML format version of the document.

Aspects of the above system may further comprise converting the HTML format version of the document to a different file type and transmitting the converted HTML format version of the document to the second user device.

Aspects of the above system may further comprise wherein converting the HTML format version of the document to a different file type comprises restoring styling elements to the HTML format version of the document.

Embodiments include a computer program product for enabling document sharing in a co-browsing session, the computer program product comprising: a non-transitory computer readable storage medium having computer readable program code embodied therewith, the computer readable program code configured when executed by a processor to perform steps comprising: initiating the co-browsing session; generating a graphical user interface (GUI) of the co-browsing session configured to display on a user device; receiving a document to be shared in the co-browsing session from the user device via a network location; in response to receiving the document, converting the document to an HTML format version of the document; and appending the HTML format version of the document to the GUI, wherein the GUI is configured to dynamically display the HTML format version of the document on the user device.

Aspects of the above computer program product may further comprise wherein converting the document to the HTML format version of the document comprises extracting textual data from the document.

Aspects of the above computer program product may further comprise wherein the GUI is configured to dynamically display the HTML format version of the document on the user device in plain text and without styling elements.

Aspects of the above computer program product may further comprise wherein the GUI is configured to dynamically display the HTML format version of the document in a modal window on the user device.

Aspects of the above computer program product may further comprise receiving authorization from the user device to enable a second user device to edit the HTML format version of the document.

Aspects of the above computer program product may further comprise converting the HTML format version of the document to a different file type and transmitting the converted HTML format version of the document to the second user device.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A computer-implemented method for enabling document sharing in a co-browsing session, the method comprising performing operations as follows on a processor of a computer system:
initiating the co-browsing session;
generating a graphical user interface (GUI) of the co-browsing session configured to display on a user device;
receiving a document to be shared in the co-browsing session from the user device via a network location;
in response to receiving the document, converting the document to an HTML format version of the document; and
appending the HTML format version of the document to the GUI, wherein the GUI is configured to dynamically display the HTML format version of the document on the user device.

2. The method of claim 1, wherein converting the document to the HTML format version of the document comprises extracting textual data from the document.

3. The method of claim 2, wherein the GUI is configured to dynamically display the HTML format version of the document on the user device in plain text and without styling elements.

4. The method of claim 1, wherein the GUI is configured to dynamically display the HTML format version of the document in a modal window on the user device.

5. The method of claim 1, further comprising receiving authorization from the user device to enable a second user device to edit the HTML format version of the document.

6. The method of claim 5, further comprising converting the HTML format version of the document to a different file type and transmitting the converted HTML format version of the document to the second user device.

7. The method of claim 6, wherein converting the HTML format version of the document to a different file type comprises restoring styling elements to the HTML format version of the document.

8. A system for enabling document sharing in a co-browsing session, the system comprising:
a processor; and
a computer-readable storage medium storing computer-readable instructions which, when executed by the processor, cause the processor to perform steps comprising:
initiating the co-browsing session;
generating a graphical user interface (GUI) of the co-browsing session configured to display on a user device;
receiving a document to be shared in the co-browsing session from the user device via a network location;
in response to receiving the document, converting the document to an HTML format version of the document; and
appending the HTML format version of the document to the GUI, wherein the GUI is configured to dynamically display the HTML format version of the document on the user device.

9. The system of claim 8, wherein converting the document to the HTML format version of the document comprises extracting textual data from the document.

10. The system of claim 9, wherein the GUI is configured to dynamically display the HTML format version of the document on the user device in plain text and without styling elements.

11. The system of claim 8, wherein the GUI is configured to dynamically display the HTML format version of the document in a modal window on the user device.

12. The system of claim 8, further comprising receiving authorization from the user device to enable a second user device to edit the HTML format version of the document.

13. The system of claim 12, further comprising converting the HTML format version of the document to a different file type and transmitting the converted HTML format version of the document to the second user device.

14. The system of claim 13, wherein converting the HTML format version of the document to a different file type comprises restoring styling elements to the HTML format version of the document.

15. A computer program product for enabling document sharing in a co-browsing session, the computer program product comprising:
a non-transitory computer readable storage medium having computer readable program code embodied therewith, the computer readable program code configured when executed by a processor to perform steps comprising:
initiating the co-browsing session;
generating a graphical user interface (GUI) of the co-browsing session configured to display on a user device;
receiving a document to be shared in the co-browsing session from the user device via a network location;
in response to receiving the document, converting the document to an HTML format version of the document; and
appending the HTML format version of the document to the GUI, wherein the GUI is configured to dynamically display the HTML format version of the document on the user device.

16. The computer program product of claim 15, wherein converting the document to the HTML format version of the document comprises extracting textual data from the document.

17. The computer program product of claim 16, wherein the GUI is configured to dynamically display the HTML format version of the document on the user device in plain text and without styling elements.

18. The computer program product of claim 15, wherein the GUI is configured to dynamically display the HTML format version of the document in a modal window on the user device.

19. The computer program product of claim 15, further comprising receiving authorization from the user device to enable a second user device to edit the HTML format version of the document.

20. The computer program product of claim 19, further comprising converting the HTML format version of the document to a different file type and transmitting the converted HTML format version of the document to the second user device.
